(19) United States
(12) Patent Application Publication
(10) Pub. No.: US 2008/0209255 A1
(43) Pub. Date: Aug. 28, 2008

(54) METHOD AND SYSTEM FOR THE SERVICE AND SUPPORT OF COMPUTING SYSTEMS

(76) Inventors: Jean-Marc L. SEGUIN, Stittsville (CA); Jay M. Litkey, Stittsville (CA); Anthony Richard Phillip White, Ottawa (CA)

Correspondence Address: VICTORIA DONNELLY, PO BOX 24001, HAZELDEAN RPO, KANATA, ON, K2M 2C3, omitted

(21) Appl. No.: 12/038,925

(22) Filed: Feb. 28, 2008

Related U.S. Application Data
(60) Provisional application No. 60/892,067, filed on Feb. 28, 2007.

(51) Int. Cl. G06F 11/07; G06F 11/28

(52) U.S. Cl. 714/2; 714/37; 714/E11.178; 714/E11.023

(57) ABSTRACT

The invention describes an end-user-initiated method and system for managing failure in a host computing system. The embodiments of the invention describe an embedded management/diagnostics system that operates independently from the failed computing system and includes the locating and connecting of an appropriate technical service provider for correcting the problem in the failed computing system.

### RELATED APPLICATIONS

This application claims priority from U.S. provisional application 60/892,067 to Seguin, Jean-Marc et al entitled “A Method And System For The Service And Support Of Computing Systems”, filed on Feb. 28, 2007, which is incorporated herein by reference.

### FIELD OF INVENTION

The invention relates to the field of computing system failure management and in particular to an end-user-initiated method and system for locating and connecting a technical service provider in the event of a computing system failure.

### BACKGROUND OF INVENTION

When a computing system fails, the end-user has a very limited set of facilities to diagnose the problem and recover from the failure. In addition to a basic set of diagnostic tools, advanced problem specific tools often need to be invoked for an effective problem diagnosis. Depending on the nature of the problem, an appropriate set of advanced techniques may need to be deployed to try and diagnose and fix the problem. If these techniques cannot adequately diagnose and recover the computing system, an appropriate technical service (TS) provider needs to be contacted for helping with recovery from the failure. In the event of the existence of multiple TS providers, an effective choice that is based on the nature of the problem, or bias of the end-user, needs to be made.

There are many issues with the current computing system service and support methods available in the current market—regardless of whether the computing system being supported is a desktop computer, mobile computer, server computer, handheld device, personal digital assistant or any other alternative computing device comprised of a central processing unit, memory and input/output functions.

One of the issues is connecting the end-user with the appropriate TS provider that can provide technical support. Another problem is getting the TS provider the correct information to handle the situation after an end-user actually gets hold of one.

Typically, when an end-user is trying to get support for a failed computing system, the end-user is required to use conventional communication systems to make contact with a support group to describe the state of the computing system. One problem with this time consuming approach is that to the end-user, the situation she/he is trying to get resolved requires immediate attention, since the end-user can no longer use/operate the computing system. Moreover, once a TS provider has been reached, the end-user is required to convey a lot of information to the TS provider, most of which is either unknown to the end-user or not readily available. In addition, using a conventional communication system, a telephone for example, to achieve this human-to-human interaction is prone to error.

Thus, there is an existing need in the industry for an improved and effective method and system for the failure management of a computing system.

### SUMMARY OF THE INVENTION

Therefore there is an object of the present invention to provide an improved method and system for the management of failures in a computing system.

According to one aspect of the invention, there is provided a method for managing a failure in a host computing system, comprising the steps of:
(a1) upon the failure of the host computing system, invoking a Host System Support Unit (HSSU) embedded in the host computing system, having its own processing element and memory and operating independently from the host computing system;
(b1) at the HSSU, retrieving a system information regarding a current status of the host computing system related to the failure; and
(c1) processing the system information retrieved in step (b1).

The step (c1) further comprises:
(a2) displaying the current status of the host computing system related to the failure, to an end-user of the host computing system; and
(b2) providing the end-user with a choice of operations regarding managing the failure of the host computing system and executing one or more of the following steps based on the operation selected by the end-user:
   (b2i) fixing problems identified in the current status of the host computing system related to the failure;
   (b2ii) running diagnostics analyzing the problems identified in the current status of the host computing system related to the failure; or (b2iii) setting up a connection between the HSSU and a Technical Support Unit (TSU) running at a remote service centre hosted by a technical service (TS) provider for providing support for managing the failure of the host computing system.

Conveniently, the step of selecting the TS provider, is performed before the step (b2iii).

The step (b2i) further comprises:
(a4) applying corrective actions for the problems identified in the current status of the host computing system related to the failure;
(b4) running a set of basic diagnostic tools for checking results of applying the corrective actions in step (a4);
(c4) retrieving the current status related to the failure of the host computing system; and
(d4) displaying the current status of the host computing system related to the failure obtained after applying the corrective actions in the step (b4) to the end-user.

The step (b2ii) further comprises:
(a5) displaying a choice of diagnostics tools to the end-user for selection; (b5) running a diagnostic tool selected by the end-user and a set of basic diagnostic tools;
(c5) retrieving the current status related to the failure of the host computing system obtained after running the diagnostic tools in step (b5); and
(d5) displaying the current status of the host computing system related to the failure to the end-user.

The step (b2iii) further comprises:
(a6) connecting the HSSU with a support routing unit (SRU) for setting up the connection between the HSSU and the TSU;
(b6) retrieving the current status related to the failure of the host computing system after the step (b2ii) for sending to the TSU; and
(c6) communicating with the TSU for managing the failure of the host computing system.

The step (c6) further comprises:
(a7) executing any one of the following steps:
   (a7i) connecting the HSSU to the TSU of a predetermined Technical Service (TS) provider through the SRU;
   (a7ii) using an alternate connection mechanism for connecting the end-user with the TS provider; or (a7iii) selecting a TS provider;
(b7) handling a support call from the TS provider including one or more of the following steps:
   (b7i) communicating with the TS provider;
   (b7ii) running diagnostic tools;
   (b7iii) mounting a remote storage for retrieving advanced diagnostic tools; or
   (b7iv) mounting a remote file system to boot the host computing system to a known and trusted operating system for performing diagnostics on the host computing system.

The step (a7ii) further comprises:
(a8) displaying an information for setting up a phone connection with the TS provider at the HSSU;
(b8) connecting the TSU with the SRU upon the TS provider receiving a phone call from the end-user;
(c8) receiving a unique key identifying the host computing system from the SRU at the TSU; and
(e8) connecting the HSSU with the TSU through the SRU using the unique key for identifying the host computing system.

The step (a7iii) further comprises:
(a9) preparing a list of TS providers at the HSSU;
(b9) displaying the list of TS providers to the end-user; and
(c9) connecting the HSSU with the SRU that sets up the connection to the TSU for the TS provider selected by the end-user.

The step (a9) further comprises one or more of the following steps:
(a10) including a name of a warranty provider for the host computing system in the list of TS providers; or
(b10) ranking the TS providers in the list of TS providers by using a set of criteria that include a past performance of the TS providers.

The method further comprising the step of collecting information regarding the performance and pricing of TS providers, and updating the ranking of the TS providers based on the collected information, the step being performed before the step (b10).

According to another aspect of the invention there is provided a method for managing a failure in a host computing system, comprising the steps of:
(a12) upon the failure of the host computing system, invoking a Host System Support Unit (HSSU) embedded in the host computing system, having its own processing element and memory and operating independently from the host computing system;
(b12) at the HSSU, retrieving a system information regarding a current status of the host computing system related to the failure;
(c12) displaying the current status of the host computing system related to the failure, to an end-user of the host computing system; and (d12) providing the end-user with a choice of operations regarding managing the failure of the host computing system.

The step (d12) comprises setting up a connection between the HSSU and a Technical Support Unit (TSU) running at a remote service centre hosted by a technical service (TS) provider for providing support for managing the failure of the host computing system.

The step (d12) comprises executing one or more of the following steps based on the operation selected by the end-user:
(a14) fixing problems identified in the current status of the host computing system related to the failure; and
(b14) running diagnostics for analyzing the problems identified in the current status of the host computing system related to the failure.

Conveniently, the method further comprises the step of selecting the TS provider, before setting up the connection between the HSSU and the TSU.

The step (a14) further comprises:
(a16) applying corrective actions for the problems identified in the current status of the host computing system related to the failure; and
(b16) running a set of basic diagnostic tools for checking results of applying the corrective actions in step (a16).

The method further comprises the steps of:
(a17) retrieving the current status related to the failure of the host computing system; and
(b17) displaying the current status of the host computing system related to the failure to the end-user.

Beneficially, the step (b14) further comprises:
(a18) displaying a choice of diagnostics tools to the end-user for selection; and
(b18) running a diagnostic tool selected by the end-user and a set of basic diagnostic tools.

The method further comprises the steps of:
(a19) retrieving the current status related to the failure of the host computing system obtained after running the diagnostic tools in step (b18); and
(b19) displaying the current status of the host computing system related to the failure to the end-user.

The method further comprises the step of connecting the HSSU with a support routing unit (SRU) for setting up the connection between the HSSU and the TSU.

According to yet another aspect of the invention, there is provided a system for managing a failure in a host computing system, comprising:
(a21) a Host System Support Unit (HSSU) embedded in the host computing system and operating independently from the host computing system, the HSSU having its own processing element and memory; and
(b21) a key unit for invoking the HSSU for handling the failure/running diagnostics on the host computing system.

The HSSU comprises:
(a22) a data acquisition module, retrieving a system information regarding a current status of the host computing system related to the failure;
(b22) a diagnostic module, running diagnostics for analyzing the problems identified in the current status of the host computing system related to the failure; and
(c22) an error correction module, fixing problems identified in the current status of the host computing system related to the failure.

The HSSU further comprises:
(a23) a HSSU communication interface module for setting up a connection between the HSSU and a Technical Support Unit (TSU) running at a remote service centre hosted by a technical service (TS) provider for providing support for managing the failure of the host computing system.

The HSSU further comprises:
(a24) a TS provider selection module, selecting a TS provider from a list of TS providers;
(b24) a call handler module, handling a call between the TS provider selected by using the TS provider selection module and the HSSU;
(a25) a Technical Support Unit (TSU) running at a remote service centre hosted by a technical service (TS) provider and providing support for managing the failure of the host computing system; and
(a26) a support routing unit (SRU) for setting up a connection between the HSSU and the TSU.

The TSU further comprises a TSU communication interface module for setting up a connection between the HSSU and the TSU for providing support for managing the failure of the host computing system.

The TS provider selection module further comprises a rank module ranking the TS providers by using a set of criteria that include a past performance of the TS providers.

The system further comprises a display unit, displaying the current status of the host computing system related to the failure, to an end-user of the host computing system, and providing the end-user with a choice of operations regarding managing the failure of the host computing system.

A computer program product for managing a failure in a host computing system, comprising a computer usable medium having computer readable program code means embodied in said medium for causing said computer to perform the steps of the method as described herein, is also provided.

### BRIEF DESCRIPTION OF DRAWINGS

Further features and advantages of the invention will be apparent from the following description of the embodiment, which is described by way of example only and with reference to the accompanying drawings in which:

FIG. 1(a) presents a high-level architecture for an embedded technical support system of the embodiment of the invention;

FIG. 1(b) presents functional components of the host system support unit (HSSU) of FIG. 1(a);

FIG. 2 shows a flowchart illustrating the steps of the method for embedded technical support in accordance with the embodiment of the invention;

FIG. 3 shows a flowchart illustrating the step of the method “Contact TS” provider of FIG. 2;

FIG. 4 shows a flowchart illustrating the step of the method “Select TS” provider of FIG. 3;

FIG. 5 shows a flowchart illustrating actions initiated by an end-user and the concomitant steps of the method of the embodiment of the present invention after receiving traditional connection information;

FIG. 6 shows a flowchart illustrating a method of setting up a connection between the end-user and the TS provider;

FIG. 7 shows a flowchart illustrating a method for ranking the TS providers and generating a TS providers list;

FIG. 8 illustrates a conceptual layout of a possible interface between a failed host computing system and a Technical Support Unit;

FIG. 9a shows HSSU residing within the Host operating system; and

FIG. 9b shows HSSU residing within the Hypervisor/Host operating system within a virtualized system.

### DETAILED DESCRIPTION OF THE EMBODIMENTS OF THE INVENTION

The present invention describes a “single-key”-invoked method and system for managing a computing system support situation that could be automatically resolved, or escalated to establish a connection between the end-user and the appropriate TS provider. A set of components is embedded in the host computing system, the failure of which is to be managed, to alleviate the problems described above in the “Background of the Invention” section. These embedded components include the components that enable quick and easy connectivity between the end-user and the appropriate TS provider right at the moment when support is needed, as well as the components necessary to provide system information and a troubleshooting/diagnostics path back to the host computing system by the support person from the TS provider.

Please note that the terms “computing system”, “host computing system”, and “host system” will be used interchangeably throughout the specification, and will mean the computing system, the failure of which needs to be managed. The host computing system can be any computing system that hosts the embedded components used in failure management. As pointed out earlier, such computing systems include a desktop computer, a laptop computer, a mobile computer, a server computer, a handheld device, a personal digital assistant or any other alternative computing device comprised of a central processing unit, memory and input/output functions.

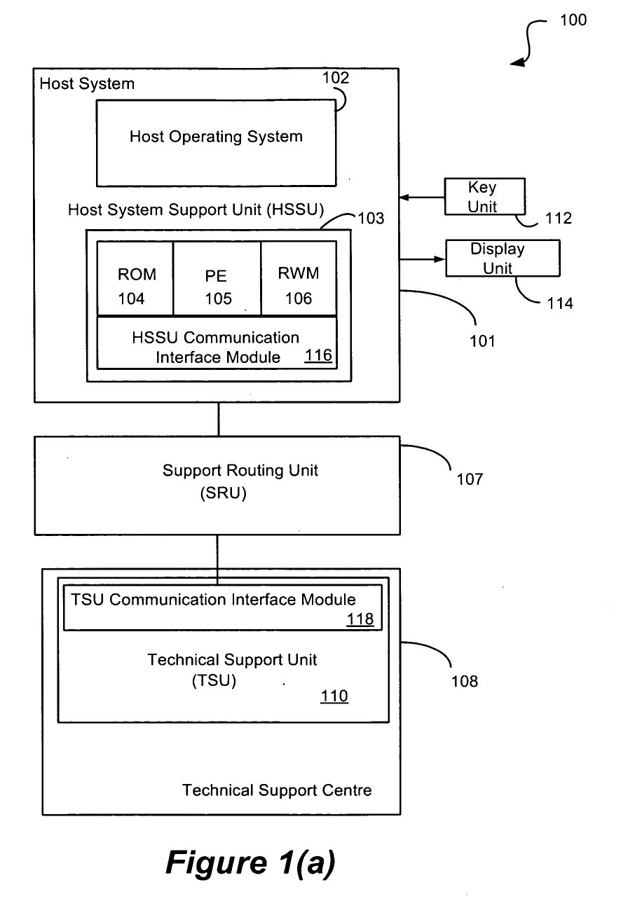

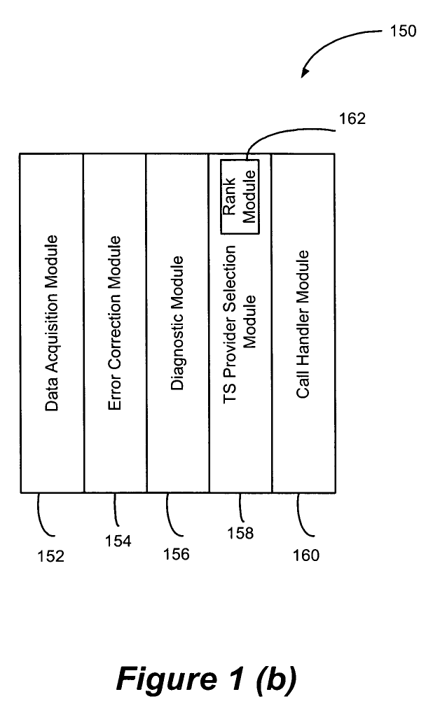

The embedded technical support system of the embodiment of this invention functions independently from the host computing system and uses two components: a unit that is embedded within a host computing system, and a technical support unit that runs on the remote technical support centre. A description of such a system is provided in diagram 100 of FIG. 1. FIG. 1 depicts a host system 101 (with an associated host operating system 102 if applicable), the failure of which is to be managed. The host system support unit (HSSU) 103 communicates with a technical support unit (TSU) 110 that runs on the technical support center 108, and can provide fault diagnosis and management for the failed host system 101. The HSSU 103 comprises a few support elements: Read Only Memory (ROM) 104, Read Write Memory (RWM) 106, a Processing Element (PE) 105 and a HSSU Communication Interface Module 116. The ROM 104 holds basic information such as permanent information about the host system 101 (e.g. make/model/serial #/asset tag). The RWM 106 is an area where configuration, information about warranty, choice of support vendor, etc can be stored. PE 105 executes the steps of the method of the invention as will be explained in detail below. The HSSU Communication Interface Module 116 is used for communication and is discussed in the next paragraph. HSSU 103 can be invoked by the end-user through a Key Unit 112: upon the failure of the host computing system the end-user can depress a key that sends a “wakeup” signal to HSSU 103. Communication with the end-user is performed with the help of a Display Unit 114 that is capable of displaying text and figures as well as producing audio tones. The display unit is used in various occasions that include the displaying of the host computing system status related to the failure, providing the end-user with a list of operations/diagnostic tools to choose from as well as presenting a list of TS providers to then end-user.

The communication between HSSU 103 and TSU 107 is achieved with the help of a Support Routing Unit (SRU) 107. The HSSU Communication Interface Module 116 is used for communicating with SRU 107. TSU 110 includes a TSU Communication Interface Module 118 for communicating with SRU 107. SRU 107 routes calls between an end-user and the appropriate TS provider. The information required by the end-user for selecting an appropriate TS provider can be provided by the HSSU 103 or can be obtained with the help of SRU 107. When a request is made for technical support, HSSU 103 connects to SRU 107, and basic information required to make a decision on where to route the call is provided. Information that can be provided includes the following: make/model/serial #/asset tag, preferred support provider (which has been provided separately for hardware, operating system (OS) and selected applications), warranty/support information, including warranty expiry information, and last health status of the hardware, OS, or selected applications. With this information, SRU 107 can return to the end-user information regarding where the call will be routed (and why) and, if not under warranty, an estimate of support costs. If the end-user does not have a TS provider, then a series of choices will be presented to the end-user allowing her/him to choose a TS provider. In this situation SRU 107 becomes a broker for the end-user and the TS provider as connections are made.

The HSSU 103 includes a series of services in a service framework that provides remote interactive controls to the host system 101 (including the associated host operating system 102 if applicable). A non-exhaustive list of services is presented below:

Direct-connect to SRU 107. This is done with an embedded Transmission Control Protocol/Internet Protocol (TCP/IP) stack and connection to a dedicated Network Interface Card (NIC) or through side-band to a shared NIC;

Voice service. This allows the end-user and the TS provider to communicate by embedded voice protocols such as the Session Initiation Protocol (SIP);

Text chat service. This allows the end-user and the TS provider to communicate by text messaging protocols such as Instant Messaging (IM). This is especially important if the voice service is unavailable or the connectivity is dial-up;

Embedded diagnostic service. This includes a series of tools that can do a first-line support check on a host system and provide a basic health status;

Local file system mounting service. This provides the HSSU 103 the ability to access the local file systems for diagnostics and repair;

Remote file system mounting service. This enables the TSU 110 to mount a file system remotely and access another series of tools not available on the local host system, or to allow the local host system to boot into a different operating system;

Video/Keyboard/Mouse service (KVM). This allows the TSU 110 to interact with the local host system 101 as the local keyboard and mouse with full view of the local video while still leaving the local connections active.

The functional components of HSSU 150 are shown in FIG. 1(b) and include the following modules that comprise computer software code or alternatively a firmware stored in a computer readable medium. These modules are used by the method for managing the failure of the host computing system that is described later in this section. Data Acquisition Module 152: that is used to retrieve the status of the host computing system related to the failure;

Error Correction Module 154: that is used for fixing problems related to the failure;

Diagnostic Module 156: that is used for running various diagnostics for analyzing the problems related to the failure;

TS Provider Selection Module 158: that is used for selecting an appropriate technical service provider that will help in correcting the problem related to the failure;

Call Handler Module 160: that is used for handling a call between the HSSU and the TSU;

Rank Module 162: is included in the TS Provider Selection Module 158 for ranking the TS providers based on criteria that include the past performance of the TS providers.

In order to evaluate the past performance of the TS providers used in TS provider ranking, the Rank Module 162 can use an end-user survey that can be typically conducted after every service. A possible survey template is described next. The end-user will be asked a number of questions to each of which the end-user must assign one of the following scores:

5 for Excellent, 4 for Very Good, 3 for Good, 2 for Fair, 1 for Poor and N/A for Not applicable to the service in question.

The Survey starts with an invitation/opt-out. The invitation describes the service fault, date, etc from the original incident report as well as the company that was chosen to provide service. This is followed by a series of questions. Every question is associated with a weight that will be used to achieve an overall score for the TS provider. An example survey is presented below. The weights are shown in square brackets and will be tuned throughout the process. All raw scores will be kept in case the weights associated with each question changes in the future.

Overall:
How satisfied are you with the service you received? [3]
What was the overall quality of telephone support? [1]
What was the overall quality of on-site support? [1]
What was the time to totally resolve your problem? [2]
What was the overall quality of problem resolutions? [2]
What was the maintenance services offered? [1]
What was the value of <company's> services compared with the price paid? [2]
How likely are you to buy from <company> again? [3]
How likely are you to recommend <company> to others? [3]

With Phone Representatives: (use N/A if phone representatives were not involved in the service provided)
Was the representative courteous during your interaction? [1]
Did the representative act with professionalism regarding your inquiry? [1]
Was the representative responsive to your inquiry? [1]
Was the representative knowledgeable about your inquiry? [1]

With On-Site Representatives: (use N/A if on-site representatives were not involved in the service provided)
Was the representative courteous during your interaction? [1]
Did the representative act with professionalism regarding your inquiry? [1]
Was the representative responsive to your inquiry? [1]
Was the representative knowledgeable about your inquiry? [1]

The survey ends with a thank you for the end-user. A reward may be provided to encourage surveys to be filled out.

The method for embedded technical support provided by the embodiment of the present invention is preferably activated with the help of a single keystroke from the end-user. As the end-user strikes the designated “Support” key provided by the Key Unit 112, HSSU 103 is invoked. A high-level description of the method is explained with the help of a sample use case that is presented next.

1. End-user strikes the “Support” key;

2. The embedded communications create a connection to the correct TS provider. This is a configurable component allowing the end-user to “select” the support group from a list ranging from the original vendor to a TS provider to their own enterprise helpdesk;

3. Once a connection to a TS provider is made, the TS provider is given some basic system information from the failed host system. What is provided in this information can be determined from the original equipment manufacturer (OEM). Typical information conveyed to the TS provider includes items such as make/model/serial#, current system status, last maintenance access, and last support access;

4. At this point the end-user and the TS provider can communicate through this connection to ascertain what the end-user thinks the situation is;

5. If the TS provider requires remote support access to the host system, the end-user is prompted by the embedded controls to authorize this access;

6. If the end-user authorizes access, the TS provider can be offered a list of support/diagnostic tools. Each of these tools can also require authorization to operate depending on the trust level established between the end-user and the TS provider. Some of these possible operations are as follows:

a. Remote test: Run a series of embedded tests;

b. Mount remote media: Connect the failed system to remote media to make a different series of tools available;

c. Boot to remote media: Allow the host system to reboot to an alternate media rather than the normal OS used by the host system;

d. Collect more information from the embedded components or the system itself. The embedded components, as a feature of manageability, can contain a cache of important system information to be accessed by remote TS providers. This is especially important in situations where the host system is no longer responsive and cannot provide this information directly.

The connection between the end-user and the support person can be disconnected at anytime by either party. Every action and result that happens within the embedded components is recorded in an audit trail. This audit trail is made available to the end-user as well as the support person. This ensures that the end-user is made aware of what the support person has done on this host system to resolve the problem as well as giving the support person evidence of what she/he did not do on the host system.

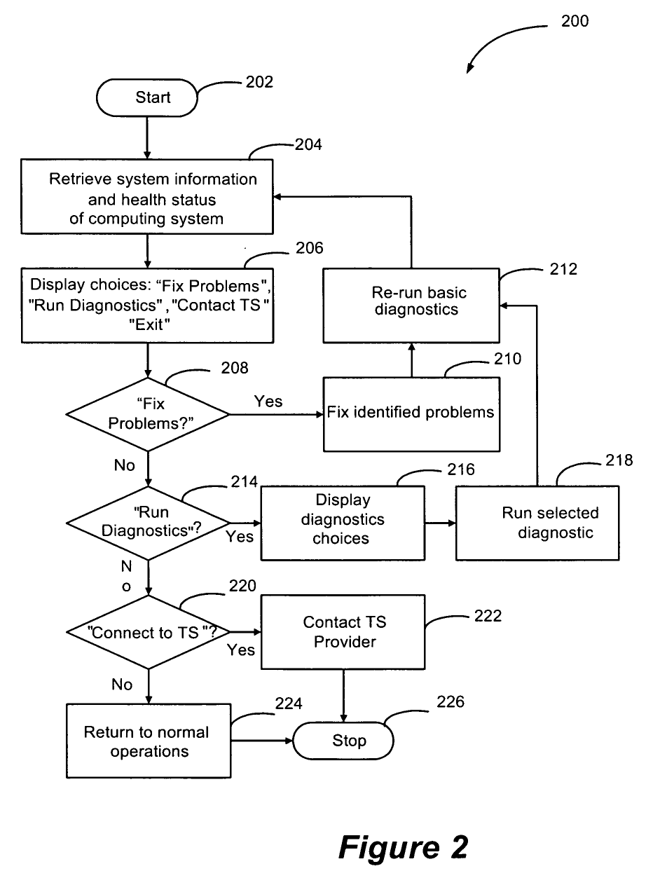

A more detailed explanation of the method provided by embodiments of this invention is explained with the help of the flowcharts presented in FIGS. 2 to 7. The method uses the modules presented in FIG. 1(b) and described earlier in the section. As explained earlier, when the end-user discovers a problem with the host system (software or hardware), she/he can activate the HSSU 103 by striking the Support key.

The method invoked by the striking of the Support key is explained with the help of flowchart 200 presented in FIG. 2. Upon start (box 202), the procedure retrieves some basic system information such as make/model and support information and some basic health status of the hardware, the last status of the operating system (box 204). A few choices are then displayed to the end-user including “Fix Problems”, “Run Diagnostics”, Contact TS”, and Exit (box 206). If the end-user chooses “Fix problems” the procedure exits “Yes” from box 208 and tries to correct the identified problem (box 210), runs the basic diagnostics tools (box 212) and loops back to the entry of box 204. Note that if the basic health status identified a problem that can be resolved by the embedded unit, the HSSU can just choose to fix the identified problem. This process can iterate over each and every problem identified. If the end-user does not choose the “Fix Problems” option the procedure exits “No” from box 208 and checks if the “Run Diagnostics” option was chosen (box 214). In the case that this option is chosen, the procedure exits “Yes” from box 214 and displays the choice of the diagnostics tools that can be run to the end-user (box 216). The selected diagnostic tools are run (box 218) and the procedure loops back to the entry of box 212. In the case that the “Run Diagnostics” option is not chosen, the procedure exits “No” from box 214 and checks whether the “Connect to TS” option is chosen. If this option is chosen, the procedure exits “Yes” from box 220, contacts the technical support unit (box 222) and completes (box 226). If the “Connect TS” option is not chosen, it means that the “exit” option is chosen and the procedure exits “No” from box 220, returns to normal operations (box 224) and completes (box 226). Note that if the end-user had arrived at this display of choices screen in error, she/he can easily return to normal operations by choosing to exit.

If there are problems identified but more information is required, or the end-user just wants to get more information, she/he can choose to run further, more targeted diagnostic tools (box 218) by choosing the “Run Diagnostics” option. The outcomes of running such diagnostic tools are displayed to the end-user and stored for future use. For either fixing an identified problem, or for running selected diagnostics, the procedure returns to the main menu (box 206), allowing the end-user to return to normal operations or to select the final choice of contacting technical support.

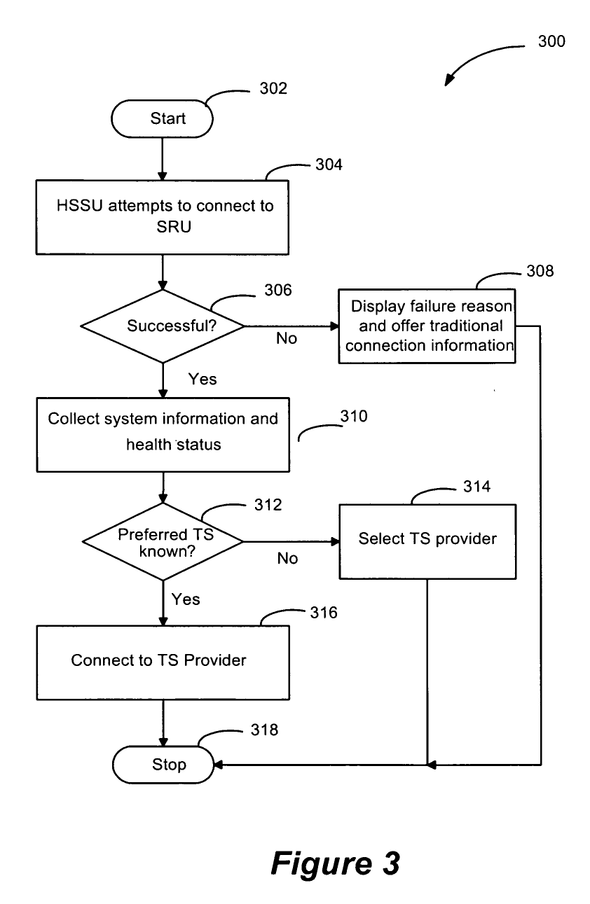

The step of the method “Contact TS” (box 222) of FIG. 2 is explained further with the help of flowchart 300 presented in FIG. 3. Upon start (box 302), HSSU attempts to connect to SRU 107, using Voice over IP (VoIP), for example, to communicate with the technical support provider. Whether or not the connection attempt is successful is checked (box 306). If the attempt is not successful, the procedure exits “No” from box 306, displays the reason for failure, provides information regarding the setting up of a traditional connection (box 308) and exits (box 318). If the connection is successful the procedure exits “Yes” from box 306 and collects system information and the health status related to the failure of the host system that will be used in reporting the problem to the technical support provider. Whether or not a preferred technical support provider is known is checked next (box 312). If such a TS provider is not known, the procedure exits “No” from box 312. A selection of an appropriate TS provider based on a list of potential TS providers presented to the end-user is then made (box 314), and the procedure exits (box 318). Note that the step of the method captured in box 314 is explained further in the following paragraph. If the preferred TS provider is known, a connection is made to this provider (box 316) and the procedure exits (box 318).

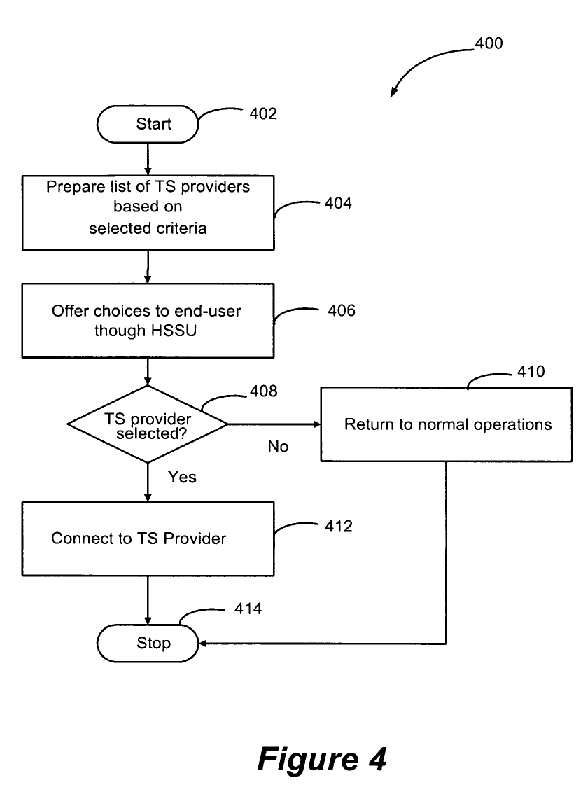

The step “Select TS provider” (box 314) of the flowchart, presented in FIG. 3, is explained in further detail with the help of FIG. 4. Upon start (box 402), the procedure prepares a list of TS providers based on selected criteria that include the type of the problem that has occurred, the location of the TS provider, the rank of the TS provider and the associated cost (box 404). This list of choices is then displayed to the end-user (box 406). Whether the end-user has selected a TS provider is checked next (box 408). If the end-user has not selected a TS provider and wants to exit, the procedure exits “No” from box 408, returns to normal operations (box 410) and completes (box 414). If a TS provider is selected, the procedure exits “Yes” from box 408, connects to the selected TS provider (box 412) and exits (box 414).

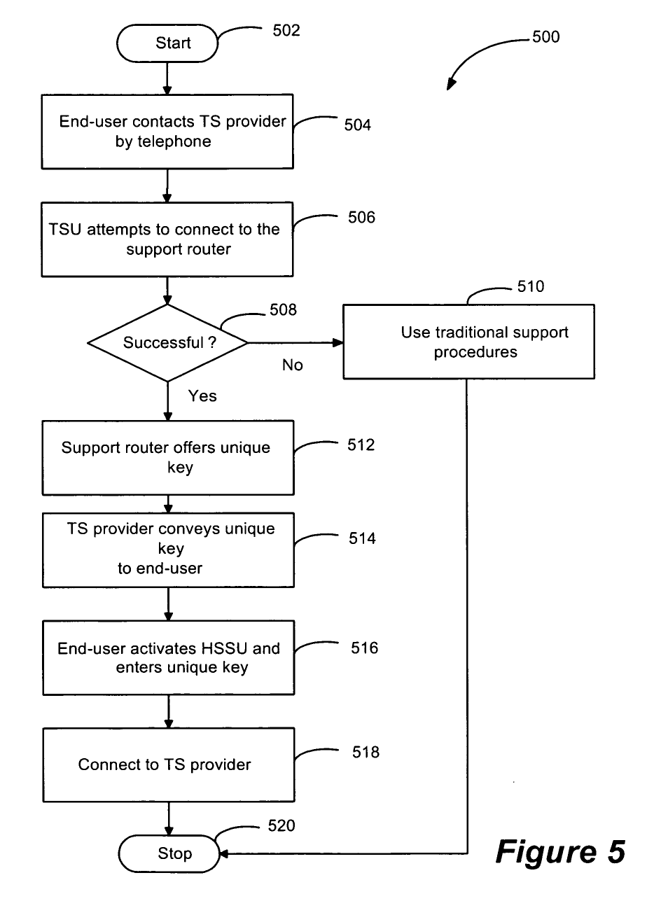

The actions initiated by the end-user after receiving the traditional connection information in the step represented by box 308 of FIG. 3 and the concomitant method executed by the embedded technical support system 100 is captured in flowchart 500 presented in FIG. 5. Note that the steps of this method are also executed if the end-user on his own decides to contact the TS provider using the traditional means. Upon start (box 502), the end-user contacts the TS provider by telephone (box 504). The TS provider then invokes the TSU that attempts to connect to SRU 107 (box 506). Whether or not the connection attempt is successful is checked next (box 508). If unsuccessful, the procedure exits “No” from box 508; traditional support procedures are then used for fault management (box 510) and the procedure exits (box 520). If the connection is successful, the procedure exits “Yes” from box 508 and SRU 107 places the TS provider connection in a pending queue offering a unique key to the TS provider (box 512). The provider conveys this unique key to the end-user (box 514). The end-user in turn activates the HSSU 103 and provides this unique key (box 516). A connection to TS provider is then made (box 518) and the procedure exits (box 520). The connection to the TS provider is made by HSSU 103 by providing the unique key that allows the support routing unit 107 to connect the HSSU 103 to the TSU 110 using the appropriate connection held in its pending queue.

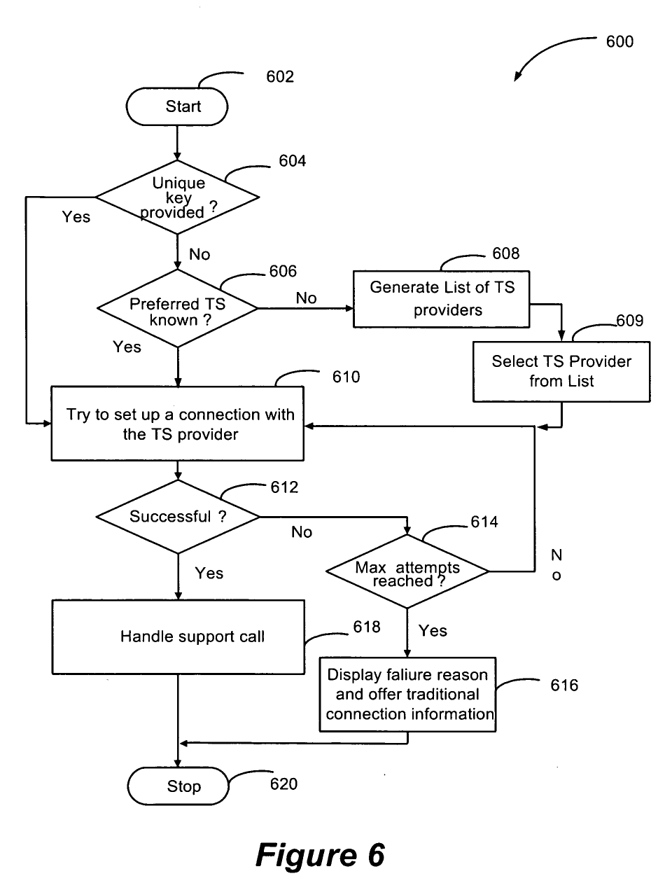

Setting up a connection with the TS provider is required in the “Connect to TS” step in the flowcharts presented in FIGS. 3, 4 and 5. The method of setting up a connection between the end-user and the TS provider is explained with the help of flowchart 600 presented in FIG. 6. Upon start (box 602), the procedure checks if a unique key has been provided to the end-user (box 604). Note that such a key is available to the end-user when the end-user in trying to contact the TS provider through traditional means the steps of which are presented in FIG. 5. If a unique key is available, the procedure exits “Yes” from box 604 and attempts to set up a connection with the TS provider using this unique key (box 610). If the key is unavailable, the procedure exits “No” from box 604 and checks if the preferred TS provider is known (box 606). If the TS provider is known, the procedure exits “Yes” from box 606, and attempts to set up a connection with this TS provider (box 610). If the preferred TS provider is unknown, the procedure exits “No” from box 606, initiates the selection of the TS provider by generating a list of potential TS providers (box 608) and displaying the list to the end-user. The procedure then gets the TS provider selected by the end-user from the list (box 609) and goes to the input of box 610. After attempting to set up a connection with the TS provider (box 610), the procedure checks if the connection attempt is successful (box 612). If unsuccessful, the procedure exits “No” from box 612, and checks if a pre-defined maximum number of call attempts is reached (box 614). If the maximum number of attempts is not reached, the procedure exits “No” from box 614 and loops back to the entry of box 610. Otherwise, it exits “Yes” from box 614, displays the reason for the failure of the connection set up attempt, provides information regarding traditional connections to the end-user (box 616), and exits (box 620). If the call attempt is successful, the procedure exits “Yes” from box 612, handles the support call (box 618) and exits (box 620). During this support call, the TS provider employee can communicate by voice over the same connection path that is used to connect the TSU 110 to the HSSU 103 in the host system 101 for exchange of data. The TS provider employee, in conjunction with the end-user, can run further diagnostics, mount remote storage to retrieve more advanced tools or mount a remote file system to boot the host system to a known, trusted operating system. Such an OS can exonerate at least the hardware and may contain more advanced tools to restore or recover the host's file system.

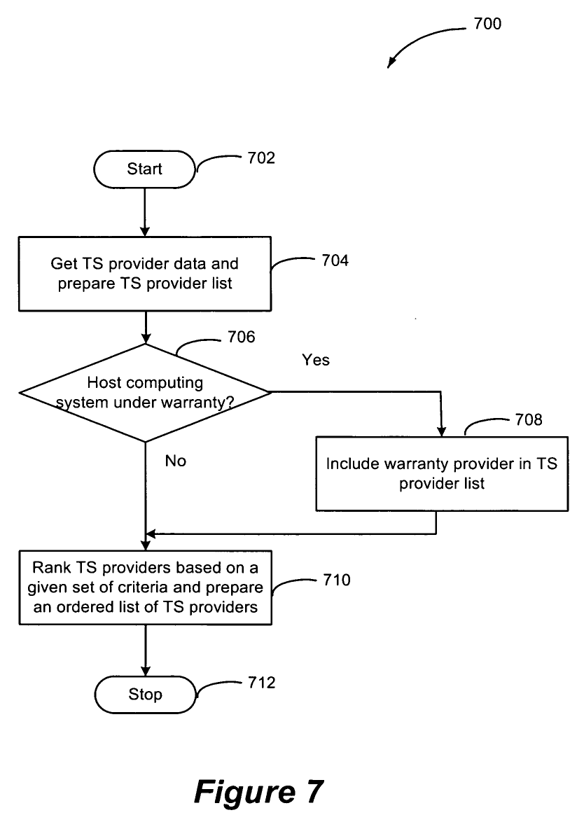

Ranking the TS providers and presenting a list of TS providers to the end-user is often required in various steps of the method that include box 608 in FIG. 6 and box 404 in FIG. 4. Generating a ranked list of the TS providers is explained further with the help of flowchart 700 presented in FIG. 7.

Upon start (box 702) the procedure gets TS provider data that is used for generating the TS provider list. This data includes both pricing information as well as past performance data for the TS providers (box 704). Whether or not the host computing system is still under warranty is checked next (box 706). If the host computing system is under warranty, the procedure exits ‘Yes’ from box 706, includes the warranty provider's information in the TS provider list (box 708) and goes to the input of box 710. If the host computing system is not under warranty the procedure proceeds to rank the TS providers for preparing an ordered list of TS providers that can be displayed to the end-user (box 710) and then exits (box 712). The rank of a TS provider may be based on various types of information that include the price estimate form the TS provider, the time required to provide the service as well as how close the TS provider's initial price estimate was to the actual charge in a number of recent transactions.

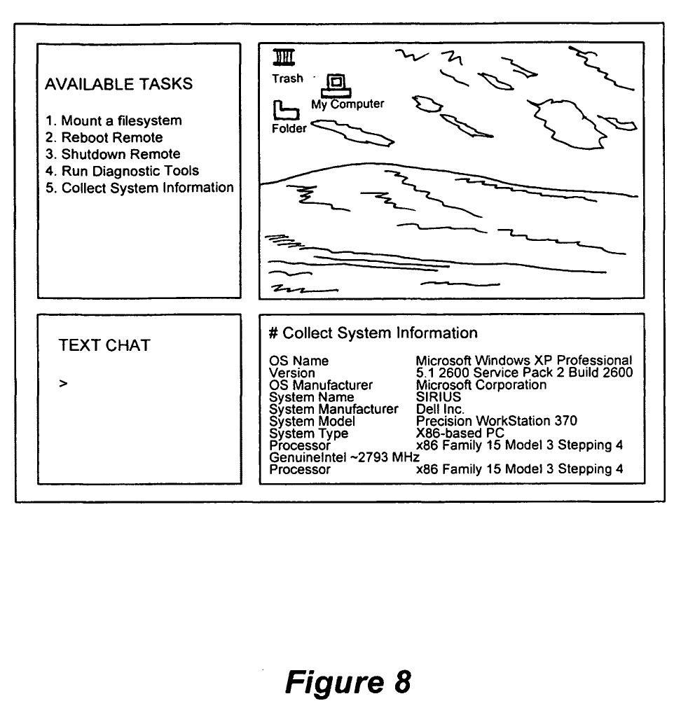

FIG. 8 shows an example of a possible interface between the host system 101 and TSU 110. The layout is divided into sections. The top left section presents the TS provider with a list of available tasks for the current situation. The top right shows what is happening on the remote screen. If the current focus on the application is within this area, the local keyboard and mouse strokes are transmitted to the remote host system. The lower left offers a text chat area to effectively handle the case in which voice connectivity is not available. The lower right shows current interactivity with HSSU. Responses to tasks as well as current status/error condition of HSSU would be displayed.

Numerous modifications and variations of the present invention are possible in light of the above teachings. Currently, the unit performing the steps of the method on the host side, referred to as the HSSU 103, is embedded within the host system 101 but outside of the primary host operating system 102. This component can be manifested in many other ways, e.g., in-band with the host operating system as an agent, out-of-band (OOB) in a privileged domain of a virtualized system, or completely OOB in adjunct hardware (in an expansion slot of the host system).

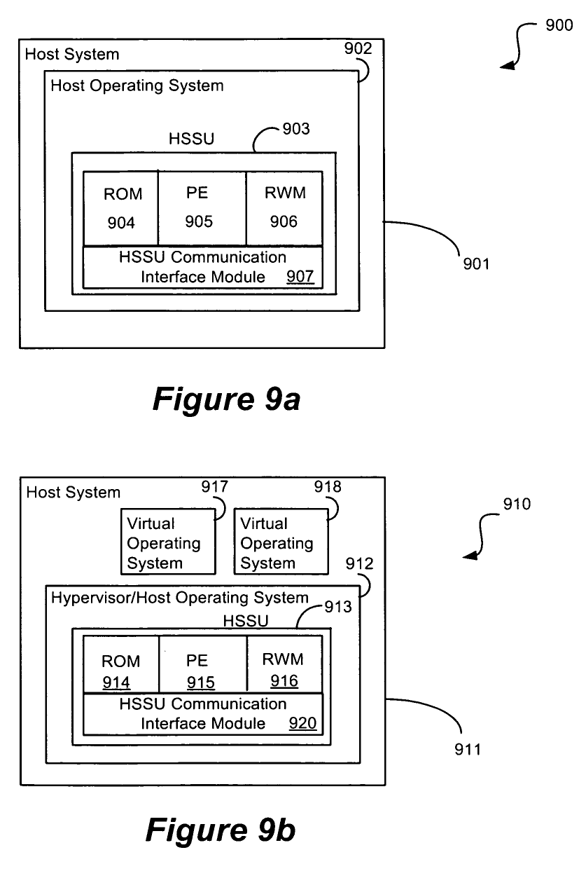

FIGS. 9a and 9b show two possible modifications for the HSSU and its physical placement in the computing system. Please note that although HSSU 903 with its components shown in FIG. 9(a) and HSSU 913 with its components shown in FIG. 9(b) are structurally similar to HSSU 103 with its components presented in FIG. 1(a), they may include modifications related to their different placements within the host computing system. FIG. 9a shows the HSSU 903 (Including ROM 904, PE 905, RWM 906 and HSSU Communication Interface Module 907) residing within the Host Operating System 902. In this case, the HSSU is susceptible to problems occurring within the Host Operating System 902 or the Host System 901 itself. Alternatively, FIG. 9b shows the HSSU 913 (Including ROM 914, PE 915, RWM 916 and HSSU Communication Interface Module 920) residing within the Hypervisor/Host Operating System 912 within a virtualized system. In this modification, the HSSU 913 is out-of-band from the Virtual Operating Systems 917 and 918 and no longer susceptible to problems occurring within the Virtual Operating Systems 917 and 918, but is still susceptible to problems occurring within the Hypervisor/Host Operating System 912 or the Host System 911 itself. It is understood that many other variations and modifications to the HSSU and its placement with regard to the host operating system are possible.

It is contemplated that instead of a “single-key”-invoked method and system, a combination of key strokes and/or hardware buttons for achieving a quick connectivity between the end-user and the appropriate service provider in the event of a computing system failure may be used. Alternatively HSSU 103 may be invoked by a signal from a separate failure detection unit. In the embodiment of the invention described the selection of a TS provider is performed after the communication set up step. Alternatively, it is possible to interchange the sequence of execution of these two steps.

Various other modifications may be provided as needed. It is therefore to be understood that within the scope of the given system characteristics, the invention may be practiced otherwise than as specifically described herein.

What is claimed is:

1. A method for managing a failure in a host computing system, comprising the steps of:
(a1) upon the failure of the host computing system, invoking a Host System Support Unit (HSSU) embedded in the host computing system, having its own processing element and memory and operating independently from the host computing system;
(b1) at the HSSU, retrieving a system information regarding a current status of the host computing system related to the failure; and
(c1) processing the system information retrieved in step (b1).

2. A method of claim 1, wherein the step (c1) further comprises:
(a2) displaying the current status of the host computing system related to the failure, to an end-user of the host computing system; and
(b2) providing the end-user with a choice of operations regarding managing the failure of the host computing system and executing one or more of the following steps based on the operation selected by the end-user:
(b2i) fixing problems identified in the current status of the host computing system related to the failure;
(b2ii) running diagnostics analyzing the problems identified in the current status of the host computing system related to the failure; or
(b2iii) setting up a connection between the HSSU and a Technical Support Unit (TSU) running at a remote service centre hosted by a technical service (TS) provider for providing support for managing the failure of the host computing system.

3. The method of claim 2, further comprising a step of selecting the TS provider, the step being performed before the step (b2iii).

4. A method of claim 2, wherein the step (b2i) further comprises:
(a4) applying corrective actions for the problems identified in the current status of the host computing system related to the failure;
(b4) running a set of basic diagnostic tools for checking results of applying the corrective actions in step (a4);
(c4) retrieving the current status related to the failure of the host computing system; and
(d4) displaying the current status of the host computing system related to the failure obtained after applying the corrective actions in the step (b4) to the end-user.

5. A method of claim 2, wherein step (b2ii) further comprises:
(a5) displaying a choice of diagnostics tools to the end-user for selection;
(b5) running a diagnostic tool selected by the end-user and a set of basic diagnostic tools;
(c5) retrieving the current status related to the failure of the host computing system obtained after running the diagnostic tools in step (b5); and
(d5) displaying the current status of the host computing system related to the failure to the end-user.

6. A method of claim 2, wherein the step (b2iii) further comprises:
(a6) connecting the HSSU with a support routing unit (SRU) for setting up the connection between the HSSU and the TSU;
(b6) retrieving the current status related to the failure of the host computing system after the step (b2ii) for sending to the TSU; and
(c6) communicating with the TSU for managing the failure of the host computing system.

7. A method of claim 6, wherein the step (c6) further comprises:
(a7) executing any one of the following steps:
(a7i) connecting the HSSU to the TSU of a predetermined Technical Service (TS) provider through the SRU;
(a7ii) using an alternate connection mechanism for connecting the end-user with the TS provider; or
(a7iii) selecting a TS provider; and
(b7) handling a support call from the TS provider including one or more of the following steps:
(b7i) communicating with the TS provider;
(b7ii) running diagnostic tools;
(b7iii) mounting a remote storage for retrieving advanced diagnostic tools; or
(b7iv) mounting a remote file system to boot the host computing system to a known and trusted operating system for performing diagnostics on the host computing system.

8. A method of claim 7, wherein the step (a7ii) further comprises:
(a8) displaying an information for setting up a phone connection with the TS provider at the HSSU;
(b8) connecting the TSU with the SRU upon the TS provider receiving a phone call from the end-user;
(c8) receiving a unique key identifying the host computing system from the SRU at the TSU; and
(e8) connecting the HSSU with the TSU through the SRU using the unique key for identifying the host computing system.

9. A method of claim 7, wherein step (a7iii) further comprises:
(a9) preparing a list of TS providers at the HSSU;
(b9) displaying the list of TS providers to the end-user; and
(c9) connecting the HSSU with the SRU that sets up the connection to the TSU for the TS provider selected by the end-user.

10. A method of claim 9, wherein step (a9) further comprises one or more of the following steps:
(a10) including a name of a warranty provider for the host computing system in the list of TS providers; or
(b10) ranking the TS providers in the list of TS providers by using a set of criteria that include a past performance of the TS providers.

11. The method as described in claim 10, further comprising the step of collecting information regarding the performance and pricing of TS providers, and updating the ranking of the TS providers based on the collected information, the step being performed before the step (b10).

12. A method for managing a failure in a host computing system, comprising the steps of:
(a12) upon the failure of the host computing system, invoking a Host System Support Unit (HSSU) embedded in the host computing system, having its own processing element and memory and operating independently from the host computing system;
(b12) at the HSSU, retrieving a system information regarding a current status of the host computing system related to the failure;
(c12) displaying the current status of the host computing system related to the failure, to an end-user of the host computing system; and
(d12) providing the end-user with a choice of operations regarding managing the failure of the host computing system.

13. The method as described in claim 12, wherein the step (d12) comprises setting up a connection between the HSSU and a Technical Support Unit (TSU) running at a remote service centre hosted by a technical service (TS) provider for providing support for managing the failure of the host computing system.

14. The method as described in claim 12, wherein the step (d12) comprises executing one or more of the following steps based on the operation selected by the end-user:
(a14) fixing problems identified in the current status of the host computing system related to the failure; and
(b14) running diagnostics for analyzing the problems identified in the current status of the host computing system related to the failure.

15. The method of claim 13, further comprising the step of selecting the TS provider, before setting up the connection between the HSSU and the TSU.

16. A method of claim 14, wherein the step (a14) further comprises:
(a16) applying corrective actions for the problems identified in the current status of the host computing system related to the failure; and
(b16) running a set of basic diagnostic tools for checking results of applying the corrective actions in step (a16).

17. The method of claim 16, further comprising the steps of:
(a17) retrieving the current status related to the failure of the host computing system; and
(b17) displaying the current status of the host computing system related to the failure to the end-user.

18. A method of claim 14, wherein the step (b14) further comprises:
(a18) displaying a choice of diagnostics tools to the end-user for selection; and
(b18) running a diagnostic tool selected by the end-user and a set of basic diagnostic tools.

19. The method of claim 18, further comprising the steps of:
(a19) retrieving the current status related to the failure of the host computing system obtained after running the diagnostic tools in step (b18); and
(b19) displaying the current status of the host computing system related to the failure to the end-user.

20. The method of claim 13, further comprising the step of connecting the HSSU with a support routing unit (SRU) for setting up the connection between the HSSU and the TSU.

21. A system for managing a failure in a host computing system, comprising:
(a21) a Host System Support Unit (HSSU) embedded in the host computing system and operating independently from the host computing system, the HSSU having its own processing element and memory; and
(b21) a key unit for invoking the HSSU for handling the failure/running diagnostics on the host computing system.

22. A system of claim 21, wherein the HSSU comprises:
(a22) a data acquisition module, retrieving a system information regarding a current status of the host computing system related to the failure;
(b22) a diagnostic module, running diagnostics for analyzing the problems identified in the current status of the host computing system related to the failure; and
(c22) an error correction module, fixing problems identified in the current status of the host computing system related to the failure.

23. A system of claim 21, wherein the HSSU further comprises:
(a23) a HSSU communication interface module for setting up a connection between the HSSU and a Technical Support Unit (TSU) running at a remote service centre hosted by a technical service (TS) provider for providing support for managing the failure of the host computing system.

24. A system of claim 21, wherein the HSSU further comprises:
(a24) a TS provider selection module, selecting a TS provider from a list of TS providers; and
(b24) a call handler module, handling a call between the TS provider selected by using the TS provider selection module and the HSSU.

25. A system of claim 21, further comprising a Technical Support Unit (TSU) running at a remote service centre hosted by a technical service (TS) provider and providing support for managing the failure of the host computing system.

26. A system of claim 25, further comprising a support routing unit (SRU) for setting up a connection between the HSSU and the TSU.

27. A system of claim 25, wherein the TSU further comprises a TSU communication interface module for setting up a connection between the HSSU and the TSU for providing support for managing the failure of the host computing system.

28. A system of claim 24, wherein the TS provider selection module further comprises a rank module ranking the TS providers by using a set of criteria that include a past performance of the TS providers.

29. A system of claim 21, wherein the system further comprises a display unit, displaying the current status of the host computing system, related to the failure, to an end-user of the host computing system, and providing the end-user with a choice of operations regarding managing the failure of the host computing system.

30. A computer program product for managing a failure in a host computing system, comprising a computer usable medium having computer readable program code means embodied in said medium for causing said computer to perform the steps of the method as described in claim 1.
